(19) United States
(12) Patent Application Publication
(10) Pub. No.: US 2007/0071330 A1
(43) Pub. Date: Mar. 29, 2007

(54) Matching data objects by matching derived fingerprints

(75) Inventors: Job Cornelis Oostveen, Eindhoven (NL); Antonius Andrianus Cornelis Maria Kalker, Mountain View, CA (US); Jaap Andre Haitsma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Phillips Electronics N.V.

(21) Appl. No.: 10/579,412

(22) PCT Filed: Nov. 8, 2004
(86) PCT No.: PCT/IB04/52334

§ 371 Date: May 15, 2006

(30) Foreign Application Priority Data
Nov. 18, 2003 (EP) 03104250.0

(51) Int. Cl. G06K 9/62; G06F 17/30

(52) U.S. Cl. 382/228; 707/3

(57) ABSTRACT

The invention relates to methods and apparatus for matching a query data object with a candidate data object by esetracting and comparing fingerprints of said data objects. In an embodiment of the invention apparatus comprising a fingerprint extraction module (110), a fingerprint matching module (210), a statistical module (120) and an identification module is provided. The fingerprint extraction module (110) receives an information signal forming part of a query object and constructs a query fingerprint. The fingerprint matching module (210) compares the query fingerprint to candidates stored in a database (215) to find at least on potentially best matching candidate. Meanwhile, the statistical module determines a statistical model of the query fingerprint so as to, for instance, determine the statistical distribution of certain information inside the query fingerprint. The threshold determiner (120) is arranged, on the basis of the distribution of the query fingerprint to derive an adaptive threshold distance within which the query fingerprint and a potentially best matching candidate may be declared similar by the identification module (130). By setting a threshold which may depend on statistical data derived from the query and/or candidate fingerprint, an improved false acceptance rate F.A.R. may be achieved.

### FIELD OF THE INVENTION

The invention relates to a method and apparatus for matching fingerprints.

### BACKGROUND OF THE INVENTION

Fingerprinting technology is used to identify media content (such as audio or video). An audio or video segment is identified by extracting a fingerprint from it, and searching the extracted fingerprint in a database in which fingerprints of known contents are stored. Content is identified if the similarity between the extracted fingerprint and the stored fingerprint is deemed sufficient.

The prime objective of multimedia fingerprinting is an efficient mechanism to establish the perceptual equality of two multimedia objects: not by comparing the (typically large) objects themselves, but by comparing the associated fingerprints (small by design). In most systems using fingerprinting technology, the fingerprints of a large number of multimedia objects along with its associated metadata (e.g. in the case of song information, name of artist, title and album) are stored in a database. The fingerprints serve as an index to the metadata. The metadata of unidentified multimedia content are then retrieved by computing a fingerprint and using this as a query in the fingerprint/metadata database. The advantage of using fingerprints instead of the multimedia content itself is three-fold: reduced memory/storage requirements as fingerprints are relatively small; efficient comparison as perceptual irrelevancies have already been removed from fingerprints; and efficient searching as the data set to be searched is smaller.

A fingerprint can be regarded as a short summary of an object. Therefore, a fingerprint function should map an object X consisting of a large number of bits to a fingerprint F of only a limited number of bits. There are five main parameters of a fingerprint system: robustness; reliability; fingerprint size; granularity; and search speed (or scalability).

The degree of robustness of a system determines whether a particular object can be correctly identified from a fingerprint in cases where signal degradation is present. In order to achieve high robustness the fingerprint F should be based on perceptual features which are invariant (at least to a certain degree) with respect to signal degradations. Preferably, a severely degraded signal will still yield a similar fingerprint to a fingerprint of an original undegraded signal. The “false rejection rate” (FRR) is generally used to express the measure of robustness of the fingerprinting system. A false rejection occurs when the fingerprints of perceptually similar objects are too different to lead to a positive identification.

The reliability of a fingerprinting system refers to how often an object is identified falsely. In other words, reliability relates to a “false acceptance rate” (FAR)— i.e. the probability that two different objects may be falsely declared to be the same.

Obviously, fingerprint size is important to any fingerprinting system. In general, the smaller the fingerprint size, the more fingerprints can be stored in a database. Fingerprint size is often expressed in bits per second and determines to a large degree the memory resources that are needed for a fingerprint database server.

Granularity is a parameter that can depend on the application and relates to how long (large) a particular sample of an object is required in order to identify it.

Search speed (or scalability), as it sounds, refers to the time needed in order to find a fingerprint in a fingerprint database.

The above five basic parameters have a large impact on each other. For instance, to achieve a lower granularity, one needs to extract a larger fingerprint to obtain the same reliability. This is due to the fact that the false acceptance rate is inversely related to fingerprint size. Another example: search speed will generally increase when one designs a more robust fingerprint.

Having discussed the basic parameters of a fingerprinting system, a general description of a typical fingerprinting system is now made.

A fingerprint may be based on extracting a feature-vector from an originating audio or video signal. Such vectors are stored in a database with reference to the relevant metadata (e.g. title, author, etc.). Upon reception of an unknown signal, a feature-vector is extracted from the unknown signal, which is subsequently used as a query on the fingerprint database. If the distance between the query feature-vector and its best match in the database is below a given threshold, then the two items are declared equal and the associated metadata are returned: i.e. the received content has been identified.

The threshold that is used in the matching process is a trade-off between the false acceptance rate (FAR) and the false rejection rate (FRR). For instance, increasing the threshold (i.e. increasing the acceptable “distance” between two fingerprints for those fingerprints to still be judged similar) increases the FAR, but at the same time it reduces the FRR. The trade-off between FAR and FRR is usually done via the so-called Neyman-Pearson approach. This means that the threshold is selected to have the smallest value which keeps the FAR below a pre-specified, allowable level. The FRR is not used for determining the threshold, but merely results from the selected threshold value.

US 2002/0178410 A1 (Haitsma, Kalker, Baggen and Oostveen) discloses a method and apparatus for generating and matching fingerprints of multimedia content. In this document, it is described on page 4 thereof how two 3 second audio clips are declared similar if the Hamming distance between two derived fingerprint blocks H₁ and H₂ is less than a certain threshold value T.

In order to analyse the choice of the threshold T, the authors of US 2002/0178410 assume that the fingerprint extraction process yields random i.i.d. (independent and identically distributed) bits. The number of bit errors will then have a binomial distribution with parameters (n, p) where n equals the number of bits extracted and p (=0.5) is the probability that a 0 or 1 bit is extracted. Since n is large, the binomial distribution can be approximated by a normal distribution with a mean μ=np and a standard deviation σ=\sqrt{np(1−p)}. Given a fingerprint block H₁, the probability that a randomly selected fingerprint block H₂ has less than T=α n errors with respect to H₁ is then given by:

$$FAR = \frac{1}{\sqrt{2 π}} {\int }_{( 1 - 2 α ) \sqrt{n}}^{∞} {ⅇ}^{- \frac{{x}^{2}}{2}} ⅆ x = \frac{1}{2} erfc ( \frac{1 - 2 α}{\sqrt{2}} \sqrt{n} ) = \frac{1}{2} ( \frac{1 - 2 T}{\sqrt{2 n}} ) \qquad ( 1 )$$

However, in practice robust fingerprints have high correlation along the time axis. This may be due to the large time correlation of the underlying video sequence, or the overlap of audio frames. Experiments for audio fingerprints show that the number of erroneous bits is normally distributed, but that the standard deviation is approximately 3 times larger than the i.i.d. case. Equation (1) therefore is modified to include this factor 3.

$$FAR = \frac{1}{2} erfc ( \frac{1 - 2 T}{3 \sqrt{2 n}} ) \qquad ( 2 )$$

The above approach assumes that the distribution between the fingerprints is stationary. Although this seems to be a reasonable assumption for certain technologies, this is definitely not the case for video fingerprinting. In video fingerprinting, the amount of “activity” in the video is directly reflected in the correlation of the fingerprint bits: prolonged stills lead to constant (i.e., very highly correlated) fingerprints, whereas a “flashy” music clip will lead to a very low correlation between the fingerprint bits. This non-stationarity leads to problems in determining an appropriate value for the threshold.

### OBJECT AND SUMMARY OF THE INVENTION

It is an aim of embodiments of the present invention to propose an arrangement for providing an adaptive thresholding technique.

According to a first aspect of the invention, there is provided a method of comparing a query fingerprint to a candidate fingerprint, the method being characterised by comprising: determining a statistical model of the query fingerprint and/or a candidate fingerprint; and on the basis of the statistical model, deriving a threshold distance within which the query fingerprint and the candidate fingerprint may be declared similar.

A second aspect of the invention provides a method of matching a query object to a known object, wherein a plurality of candidate fingerprints representing a plurality of candidate objects are pre-stored in a database, the method comprising receiving an information signal forming part of the query object and constructing a query fingerprint therefrom and comparing the query fingerprint to a candidate fingerprint in the database, the method being characterised in that it further comprises the steps of: determining a statistical model for the query fingerprint and/or the candidate fingerprint; and on the basis of the statistical model, deriving a threshold distance within which the query fingerprint and the candidate fingerprint may be declared similar.

In the methods of the first and second aspects, the derivation of a threshold based upon a statistical model of the particular fingerprint provides adaptive threshold setting which may optimise the F.A.R. according to query fingerprint type/internal characteristics giving improved matching qualities over the application of an arbitrary thresholding system.

Preferably, if a candidate fingerprint is found to be separated from the query fingerprint by a distance less than the threshold distance, and the distance between the candidate and the query fingerprint is less than the distance between any other candidate fingerprint and the query fingerprint, then the candidate fingerprint is declared the best matching candidate fingerprint and the candidate object represented by the best matching candidate fingerprint and the query object represented by the query fingerprint are deemed to be the same.

Preferably, the statistical model comprises the result of performing an internal correlation on the query fingerprint and/or the candidate fingerprint.

Preferably, the fingerprints comprise binary values and the statistical model is computed for the query fingerprint by determining a transition probability q for the query fingerprint by determining how many bits of a query fingerprint frame F(m,k) are different from their corresponding bit in their preceding fingerprint frame F(m,k−1) and dividing the number of transitions by a maximum value M*(k−1), which would be obtained if all fingerprint bits were of an opposite state to their corresponding preceding bit, where each fingerprint comprises M bits per frame and spans K frames, in which k is the frame index (ranging from 0 to K) and m is the bit-index within a frame (ranging from 0 to M).

The threshold distance T may then be computed from the following equation based on a desired False Acceptance Rate (FAR):

$$FAR = \frac{1}{2} erfc ( \frac{1 - 2 T}{\sqrt{2 n}} \sqrt{\frac{1 + {( 1 - 2 q )}^{2}}{1 - {( 1 - 2 q )}^{2}}} ) \qquad ( 4 )$$

In a third aspect, the invention provides apparatus for matching a query object to a known object, the apparatus comprising a fingerprint extaction module for receiving an information signal forming part of a query object and constructing a query fingerprint therefrom and a fingerprint matching module for comparing the query fingerprint to candidate fingerprints stored in a database to one or more candidate fingerprints, the apparatus being characterised in that it further comprises: a statistical module for determining a statistical model of the query fingerprint and/or one or more of the one or more candidate fingerprints; a threshold determiner, deriving on the basis of the statistical model, a threshold distance T within which the query fingerprint and a candidate fingerprint may be declared similar; and an identification module arranged such that if a candidate fingerprint is found to be separated from the query fingerprint by a distance less than the threshold distance T, and the distance between the candidate and the query fingerprint is less than the distance between any other candidate fingerprint and the query fingerprint, then the candidate fingerprint is declared the best matching candidate fingerprint and the candidate object represented by the best matching candidate fingerprint and the query object represented by the query fingerprint are deemed to be the same.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 shows a functional block diagram illustrating a fingerprinting method with an adaptive threshold in accordance with an embodiment of the invention;

FIG. 2 is a flow diagram explaining in general the process involved in finding and matching fingerprints in accordance with an embodiment of the invention;

FIG. 3 is a flow diagram illustrating in general the methodology for determining an adaptive threshold in accordance with an embodiment of the present invention; and

FIG. 4 is a flow diagram illustrating a specific adaptive threshold setting methodology in accordance with embodiments of the invention.

### DESCRIPTION OF EMBODIMENTS

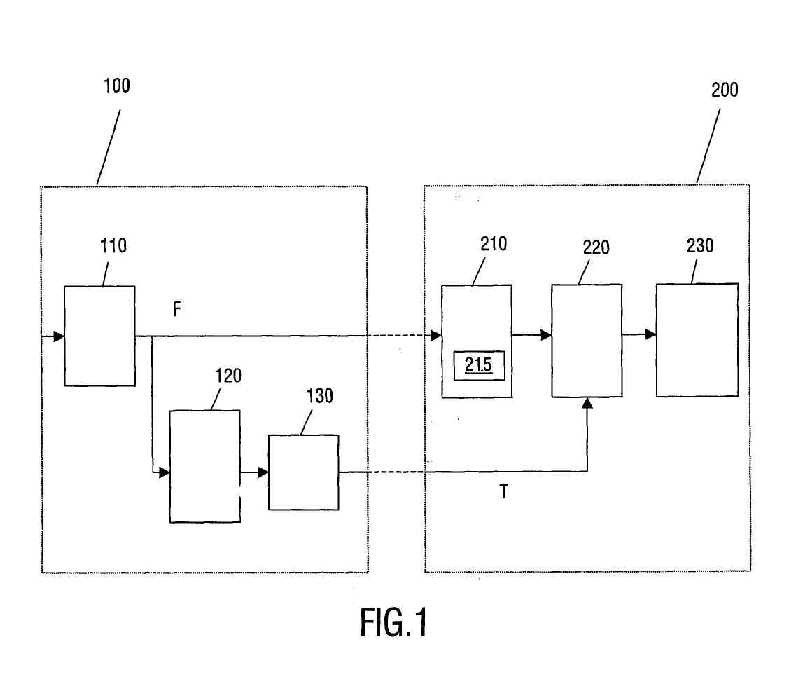

Referring to FIG. 1, there is shown a functional block diagram divided into a client side 100 and a database server side 200. At the client side, an object is received by a fingerprint extraction module 110 and a query fingerprint F computed for the object. The query fingerprint F is, on the one hand, passed to an statistical module 120 and, on the other hand, also passed to the database server side 200. The statistical module 120 determines a measure of randomness/correlation (for instance, it may determine the internal correlation) of the query fingerprint F and passes this information to a threshold determiner 130. The threshold determiner 130, on the basis of the information from the module 120 adaptively sets a threshold level T and passes this threshold level T to the database server side 200.

At the database server side 200, a matching module 210 receives the query fingerprint F from the client side 100 and looks for the best match of that fingerprint within a database of known fingerprints. The best match information is then passed to a threshold comparison module 220 to determine whether a best matching candidate fingerprint is close enough (within threshold distance T) to the query fingerprint to determine the identity of the input object with the matched object corresponding to the candidate fingerprint. In the case where the fingerprint F takes binary values, the threshold comparison module 220 might, for instance, compare the Hamming distance between a fingerprint block H₁ and a fingerprint block H₂ relating to the best match in the database 210 and check to see whether the Hamming distance between the two blocks is below the threshold distance T, supplied to the comparison module 220 from the threshold determining module 130. An identification decision is made by identification module 230 so that if the Hamming distance between the two derived fingerprint blocks is below the threshold distance T then the unidentified query object is declared similar to the object found in the database and the relevant metadata is returned.

In the above description the query fingerprint F and the threshold T are sent by the client side 100 to the database server side 200. Here, of course, it could be noted that the threshold T could also be determined at the database server side 200 and that, therefore, modifications of the aforementioned block diagram are of course possible.

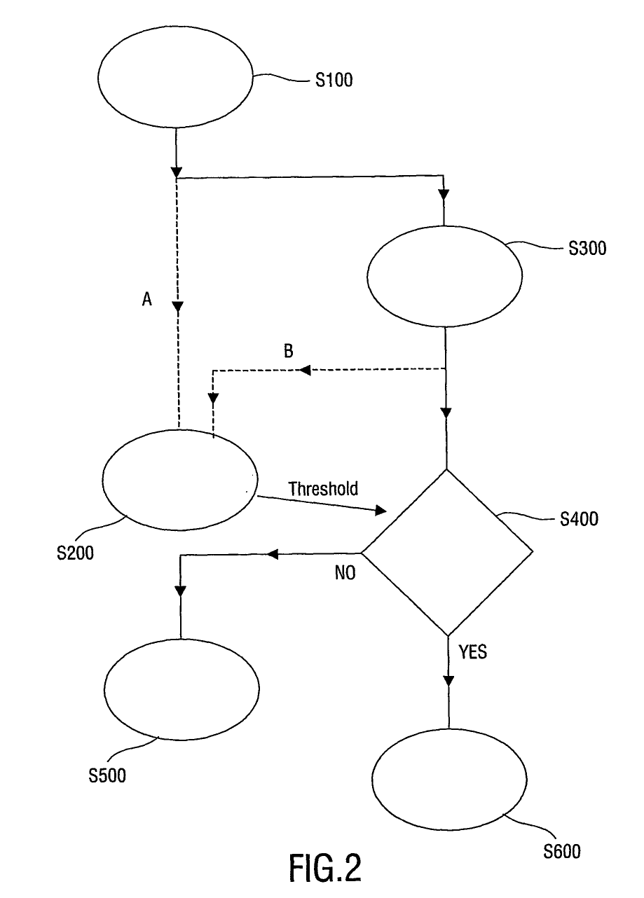

Referring now to FIG. 2, there is shown a flow diagram which explains, in general, the operation of the components of the block diagram of FIG. 1 in finding and matching fingerprints.

In a step S100, an object sample (e.g. in the case of video a short “clip”) is received and a query fingerprint determined based upon the sample. This query fingerprint may be determined in accordance with any suitable prior art method (such as disclosed in US 2002/0178410 A1). In a step S200 (reached by pathway “A”), a threshold for the query fingerprint is determined in accordance with the particular characteristics (randomness/correlation) of the query fingerprint.

In a step S300, which may be carried out in parallel with step S200, the query fingerprint is matched to fingerprints held on the database server side 200, to return a best matching candidate. Again, this matching process may be performed conventionally, so as to return the closest match to the query fingerprint.

In the step S300, the “distance” between the query fingerprint and the best match candidate will be determined and, in a step S400, it is checked whether or not the “distance” is less than the threshold distance determined in step S200. If the distance between the query fingerprint and the best match candidate is found in step S400 to be greater than the threshold, then in step S500 the result is returned that no matching object to the query object has been found. On the other hand, if the distance between query fingerprint and best match candidate fingerprint is less than the threshold distance in step S400, then in step S600 a match is declared between the query object and the object in the database relating to the best matching candidate. Metadata etc., of the best matching object may then be returned to a user.

In FIG. 2, the pathway “A” denoted by the broken lines leading to step S200 from S100 denote one option for setting a threshold T=T1 based on the query fingerprint. Alternatively however, pathway “A” may be disregarded and a threshold T=T2 may be based upon the characteristics of the best matching candidate. This possibility is denoted by the alternative pathway B from S300 to S200.

In a further alternative, the threshold T may be set based upon a combination of the characteristics of both the query fingerprint and the best matching candidate fingerprint e.g. by setting a threshold at the average between two derived adaptive thresholds T1, T2.

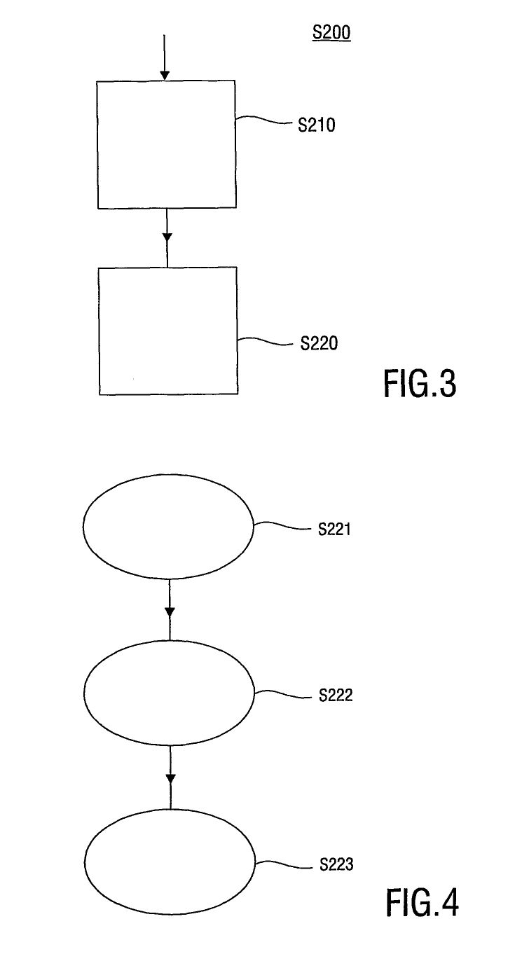

FIG. 3 is a flow diagram illustrating the general methodology for adaptively determining a given threshold T.

In step S210, the query candidate fingerprint is received and a measure of randomness of the fingerprint determined, then in step S220 a threshold distance is set according to the measure of randomness found in step S210.

As will be appreciated from the above and from the explanation in relation to FIG. 1, the threshold value T (T1 or T2) used in the comparison is adapted to the randomness/correlation in either the query-fingerprint or/and the best matching candidate. More specifically, in the case of threshold determination for a query fingerprint, the correlation of the query fingerprint is determined and, from this correlation, the threshold to be used during matching is computed. The less random the internal correlation is found to be, the smaller the threshold distance T can be set without adversely affecting the FRR.

As stated, the threshold is determined upon the internal correlation of the query fingerprint, a best matching candidate fingerprint or a combination of the two. In cases where the fingerprint is binary and the fingerprint-bits behave like a Markov-process, a solution can be derived for adaptively setting the threshold.

The solution to the adaptive threshold setting problem is shown in FIG. 4. In a step S221, the internal correlation of the fingerprint in question is determined, in step S222 the transition probability for the fingerprint is determined based upon the internal correlation and in step S223, the threshold distance is set adaptively, based upon both the transition probability (explained below) and a desired false acceptance rate.

Let the fingerprint consist of M bits per frame and span K frames. In this case, the fingerprint can be denoted F(m,k), where k is the frame index (ranging from 0 to K−1) and m is the bit-index within a frame (ranging from 0 to M−1). Let q denote the probability that a fingerprint-bit extracted from frame k is unequal to the corresponding fingerprint bit from frame k−1 by (q=Prob[bit(m,k)≠bit(m,k−1)]). This probability q is called the transition probability. In this case the correlation increases (compared to the case of purely random bits, in which q=½) by a factor

$$\sqrt{\frac{1 + {( 1 - 2 q )}^{2}}{1 - {( 1 - 2 q )}^{2}}} \qquad ( 3 )$$

As a consequence, the False Acceptance Rate FAR is described by the relation

$$FAR = \frac{1}{2} erfc ( \frac{1 - 2 T}{\sqrt{2 n}} \sqrt{\frac{1 + {( 1 - 2 q )}^{2}}{1 - {( 1 - 2 q )}^{2}}} ) \qquad ( 4 )$$

Use of the above relation for computing an adaptive threshold from the desired FAR and the computed transition probability q may be summarised as follows:

Extract fingerprint F

Determine the transition probability q for fingerprint F, as follows:

(a) Determine how many of the fingerprint bits F(m,k) are different from their predecessor F(m,k−1).

(b) Divide the number of transitions, as computed in step (a) by the theoretical maximum M*(K−1), which would be obtained if for each frame, all fingerprint bits would be the opposite from the bits in the previous frame to determine the transition probability q=(number of bit-transitions)/(M*(K−1)).

Determine the threshold T which is to be used for matching this specific query fingerprint F from the computed value q, and a defined pre-agreed False Acceptance Rate using relation (4).

From the above, the threshold T may be adaptively set for T=T1 (based on correlation of query fingerprint above), or T=T2 (based on correlation of best match fingerprint above), or T=T3 (based on a combination of T1,

$$T 2 [ e . g . T = \frac{( T 1 + T 2 )}{2} ] .$$

Then, in the decision stage if the Hamming distance is less than T, declare the underlying objects to be the same.

In the above specific examples of the present invention the threshold distance is set adaptively based on the internal characteristics of a particular query sample or, indeed, of a particular candidate sample or set of samples. However, whilst the specific examples described take the internal characteristics in question to be randomness/correlation, it will be realised that other types of statistical distribution might apply to certain types of information signal and that, therefore, the invention may be legitimately extended to providing adaptive thresholds according to any given applicable “statistical model” to which a query sample or a candidate sample fingerprint is expected to conform.

Further, the skilled man will realise that whilst the FIG. 2 through 4 flow diagrams show one arrangement for implementing the invention, other arrangements are possible. For instance, rather than returning a single best match candidate in step S300 of FIG. 2, a plurality of close matching candidates within a threshold distance may be returned and processed in parallel (or less advantageously in series) to thereafter calculate the “best” match. The invention can also be applied using so-called “pruning” techniques in which certain candidates within the database can be immediately discarded if it is obvious that they can never make a match—searching/matching can then be done within a much reduced search space.

In accordance with embodiments of the invention, methods and apparatus for setting an adaptive threshold are disclosed, in which the threshold depends upon specific characteristics of a fingerprint. The particular method is very suitable for use in matching of video content, but is not limited to this. The techniques described may be applied to various different areas of technology and various different signal types, including, but not limited to, audio signals, video signals, multimedia signals.

The skilled man will realise that the processes described may be implemented in software, hardware, or any suitable combination.

In summary, the invention relates to methods and apparatus for fingerprint matching. In an embodiment of the invention apparatus comprising a fingerprint extraction module (110), a fingerprint matching module (210), a statistical module (120) and an identification module is provided. The fingerprint extraction module (110) receives an information signal forming part of a query object and constructs a query fingerprint. The fingerprint matching module (210) compares the query fingerprint to candidates stored in a database (215) to find at least one potentially best matching candidate. Meanwhile, the statistical module determines a statistical model of the query fingerprint so as to, for instance, determine the statistical distribution of the query fingerprint. The threshold determiner (120) is arranged, on the basis of the distribution of the query fingerprint to derive an adaptive threshold distance T within which the query fingerprint and a potentially best matching candidate may be declared similar by the identification module (130). By setting a threshold in an adaptive manner according to the statistical distribution of the query fingerprint, an improved false acceptance rate F.A.R and other advantages may be achieved.

1. A method of comparing a query fingerprint to a candidate fingerprint, the method being characterised by comprising: determining a statistical model of the query fingerprint and/or a candidate fingerprint and, on the basis of the statistical model, deriving a threshold distance within which the query fingerprint and the candidate fingerprint may be declared similar.

2. A method of matching a query object to a known object, wherein a plurality of candidate fingerprints representing a plurality of candidate objects are pre-stored in a database, the method comprising receiving an information signal forming part of the query object and constructing a query fingerprint therefrom and comparing the query fingerprint to a candidate fingerprint in the database, the method being characterised by the further steps of:
determining a statistical model for the query fingerprint and/or the candidate fingerprint; and
on the basis of the statistical model, deriving a threshold distance within which the query fingerprint and the candidate fingerprint may be declared similar.

3. The method of claim 1, wherein if a candidate fingerprint is found to be separated from the query fingerprint by a distance less than the threshold distance, and the distance between the candidate and the query fingerprint is less than the distance between any other candidate fingerprint and the query fingerprint, then the candidate fingerprint is declared the best matching candidate fingerprint and the candidate object represented by the best matching candidate fingerprint and the query object represented by the query fingerprint are deemed to be the same.

4. The method of claim 1, wherein the statistical model comprises the result of performing an internal correlation on the query fingerprint and/or the candidate fingerprint.

5. The method of claim 4, wherein the fingerprints comprise a plurality of frames containing binary values and the statistical model is computed for the query fingerprint by determining a transition probability q for the query fingerprint by determining how many bits of a frame of the query fingerprint F(m,k) are different from their corresponding bit in their preceding fingerprint frame F(m,k−1) and dividing the number of transitions by a maximum value M*(k−1), which would be obtained if all fingerprint bits were of an opposite state to their corresponding preceding bit, where each fingerprint comprises M bits per frame and spans K frames, in which k is the frame index (ranging from 0 to K) and m is the bit-index within a frame (ranging from 0 to M).

6. The method of claim 5, wherein the threshold distance T is computed from the following equation based on a desired False Acceptance Rate (FAR):
$$FAR = \frac{1}{2} erfc ( \frac{1 - 2 T}{\sqrt{2 n}} \sqrt{\frac{1 + {( 1 - 2 q )}^{2}}{1 - {( 1 - 2 q )}^{2}}} )$$

7. Apparatus for matching a query object to a known object, the apparatus comprising a fingerprint extraction module (110) for receiving an information signal forming part of a query object and constructing a query fingerprint therefrom and a fingerprint matching module (210) for comparing the query fingerprint to candidate fingerprints stored in a database (215) to one or more candidate fingerprints, the apparatus being characterised by also comprising:
a statistical module (120) for determining a statistical model of the query fingerprint and/or one or more of the one or more candidate fingerprints;
a threshold determiner (120) deriving, on the basis of the statistical model, a threshold distance T within which the query fingerprint and a potentially best matching candidate fingerprint may be declared similar; and
an identification module (230) arranged such that if a candidate fingerprint is found to be separated from the query fingerprint by a distance less than the threshold distance T, and the distance between the candidate and the query fingerprint is less than the distance between any other candidate fingerprint and the query fingerprint, then the candidate fingerprint is declared the best matching candidate fingerprint and the candidate object represented by the best matching candidate fingerprint and the query object represented by the query fingerprint are deemed to be the same.

8. The apparatus of claim 7, wherein the statistical module (120) performs an internal correlation on the query fingerprint and/or the one or more candidate fingerprints.

9. The method of claim 8, wherein the fingerprints comprise a plurality of frames containing binary values and the statistical module (120) computes the statistical model for the query fingerprint or/and the candidate fingerprint by determining a transition probability q by determining how many bits of a frame of the query fingerprint F(m,k) are different from their corresponding bit in the preceding fingerprint frame F(m,k−1) and dividing the number of transitions by a maximum value M*(k−1), which would be obtained if all fingerprint bits were of an opposite state to their corresponding preceding bit, where each fingerprint comprises M bits per frame and spans K frames, in which k is the frame index (ranging from 0 to K) and m is the bit-index within a frame (ranging from 0 to M).

10. The method of claim 9, wherein the threshold determiner (130) computes the threshold distance T from the following equation based on a desired False Acceptance Rate (FAR):
$$FAR = \frac{1}{2} erfc ( \frac{1 - 2 T}{\sqrt{2 n}} \sqrt{\frac{1 + {( 1 - 2 q )}^{2}}{1 - {( 1 - 2 q )}^{2}}} )$$
